(19) United States
(12) Patent Application Publication
(10) Pub. No.: US 2010/0096845 A1
(43) Pub. Date: Apr. 22, 2010

(54) Off-road mobile services self-powered trailer with redundant power supply

(76) Inventor: Charles H. Leahy, Asheville, NC (US)

Correspondence Address: TRIANGLE PATENTS, P.L.L.C., P.O. BOX 28539, RALEIGH, NC, 27611-8539, US

(21) Appl. No.: 12/462,684

(22) Filed: Aug. 8, 2009

Related U.S. Application Data
(60) Provisional application No. 61/188,352, filed on Aug. 8, 2008.

(51) Int. Cl. B62D 63/06; E04B 1/74; H02K 7/18

(52) U.S. Cl. 280/789; 52/404.1; 290/1 A

(57) ABSTRACT

A mobile trailer unit including an integrated self-contained, independent power systems and each unit being constructed and configured with a reinforced frame and all-terrain mobility suspension and traction systems, further including a superior insulated envelope construction for providing interior temperature management, including effective cooling or heating capabilities even in extreme temperature conditions.

### CROSS-REFERENCE TO RELATED APPLICATIONS

This non-provisional utility patent application is related to the following co-pending application: it claims priority from U.S. provisional patent application Ser. No. 61/188,352 filed Aug. 8, 2008, which is incorporated herein by reference in its entirety.

### BACKGROUND OF THE INVENTION

1. Field of the Invention

The present invention relates generally to mobile trailers. Further, the present invention relates to mobile trailers for rapid response services including power supply.

2. Description of the Prior Art

Generally, it is known in the art to provide trailers, such as retrofitted standard highway-capable trailers, outfitted with cabinets, sinks, HVAC, and a gas-powered generator for a power supply, for use by rapid responders or relief agencies to emergency situations. An example of prior art medical trailers includes US Patent Application Pub. No. 2007/0102946. However, this provides only limited power supply, and requires diesel or other fuel to be readily available on location. Also, these highway trailers are not designed for off-road conditions, and so only provide limited services access to more remote locations, including disaster settings where existing road infrastructure is compromised or damaged, or off-road areas. Additionally, while insulation is provided in prior art trailers, it is insufficient for maintaining climate control in extreme conditions, whether for cooling or for heating to maintain climate control within the trailer unit. Also, humidity control is not effectively provided by the prior art. Thus, there remains a need for increased mobility and rugged trailer design, as well as increased independent power supply for services trailers for emergency, relief and rapid responder applications.

### SUMMARY OF THE INVENTION

The present invention is directed to a mobile trailer having self-power capability and reinforced frame and all-terrain mobility suspension and traction systems suitable for use in first-responder, relief or emergency services applications.

A first aspect of the present invention is to provide a mobile trailer unit including self-contained, independent power systems (integrated) and each unit being constructed and configured with a reinforced frame and all-terrain mobility suspension and traction systems.

A second aspect of the present invention is to provide a distributed network of mobile trailer units wherein each unit includes self-contained, independent power systems (integrated) and each unit is constructed and configured with a reinforced frame and all-terrain mobility suspension and traction systems.

Still another aspect of the present invention is to provide a ruggedized mobile trailer including a superior insulated envelope construction for providing interior temperature management, including effective cooling or heating capabilities even in extreme temperature conditions.

These and other aspects of the present invention will become apparent to those skilled in the art after a reading of the following description of the preferred embodiment when considered with the drawings, as they support the claimed invention.

### BRIEF DESCRIPTION OF DRAWINGS

The FIGS. 1-22 provide various views of the mobile trailer and/or components of an embodiment of the present invention, showing “deck on frame” construction to provide ruggedized mobility including off-road conditions, and further provides various views of panel construction, electrical schematics, etc. for modular components of a trailer before assembly.

FIG. 1 illustrates a top view of a trailer unit according to the present invention.

FIG. 2 illustrates a side view and end view of the trailer unit of FIG. 1.

FIG. 3 illustrates an end view of the trailer of FIG. 1.

FIGS. 4-7 illustrate multiple views of insulated structural panels or lining used with the present invention.

FIGS. 8-17 illustrate a view of the top plate, bottom plate, and header used with the present invention.

FIGS. 18-22 illustrate an exterior isometric view and other views of a section of the trailer unit according to the present invention.

### DETAILED DESCRIPTION

The present invention is directed to a mobile trailer having self-power capability and reinforced frame and all-terrain mobility suspension and traction systems suitable for use in first- or rapid-responder, emergency, relief and/or military services applications. Two key factors, namely power availability and off-road maneuverability, are essential for providing fully-functional and independently operable service vehicles that also function as portable work facilities and/or residential or other occupancy-based facilities, including power.

One embodiment of the present invention includes a mobile trailer unit having self-contained, independent power systems and each unit being constructed and configured with a reinforced frame and all-terrain mobility suspension and traction systems. Regarding the power systems, since remote, portable service operations are subject to limited or no power availability from infrastructure, it is critical and essential that the mobile trailer unit of the present invention be operable from and includes independent power supply from at least one renewable (human, solar, wind, hydro, etc.) power source. Basic diesel fuel generators of the prior art are insufficient for the application of the present invention, since fuel supplies may not be consistently available or accessible at all, depending upon location of the unit for services operation. Also, electrical connectivity may not be available from traditional grid supplies, again since location may be remote and/or emergency situation may find those infrastructures compromised, damaged, destroyed, or non-functional. Thus, the present invention power supply preferably integrates and includes more than one source of power, selected from fuel-based generators, battery power, human (e.g., crank generator) power, solar, wind, hydro, battery-based, and combinations thereof. Since diesel-generator and battery back-up are common in the prior art, the present invention provides preference for renewable energy, such as one or more redundant systems of renewable energy.

Regarding the trailer unit insulation, preferred embodiments include a trailer having an insulated envelope construction surrounding the internal cavity of the trailer for providing interior temperature management, including climate control, or insulative cooling and/or heating capabilities for maintaining a predetermined internal temperature and humidity control within the trailer in normal and extreme temperature conditions.

Regarding the trailer unit framework, suspension, and traction systems, preferably the present invention provides a reinforced axle and frame, and rugged suspension system capable of handling off-road conditions, including uneven surfaces, mixed terrain, etc. Preferably, the trailer body is molded aerodynamically for improved fuel efficiency. The trailer body dimensions range between about 8 ft and about 30 feet long (not including the trailer tongue that is about 5 ft.) and preferably about as wide as standard vehicle trailers suitable for normal highway or road travel/transport. Preferably, towing of the trailer unit is effected by small to mid-sized truck, such as a rugged pick-up truck or sport utility vehicle. The trailer units may be self-driven or attachable to another vehicle by standard towing connection means known in the art. In the case of self-driven construction, preferably the trailer unit functions as a hybrid vehicle, wherein the independent power supply inputs are coupled to the axle(s) of the vehicle to provide power, or are coupled to charge a battery in the case of an electric-powered vehicle. This self-powering provides even greater remote access and use of the vehicle, including emergency situations where gasoline and other fuel supplies may not be available.

Preferably, the power systems are integrated with the mobile trailer unit framework and functional systems. This provides easy operability of equipment, without special adapters, chargers, or other converter requirements. Particularly in the case of testing, medical, or other equipment, whether industrial, commercial, household, or military grade, the power conduits preferably provide for immediate connectivity and operability of equipment on a plug-and-use basis within the trailer unit. Computer, video conferencing and other equipment similarly can be immediately used within the trailer setting. Outside power outlets as well as interior power outlets may be provided with the trailer units of the present invention.

Preferably, a distributed network of mobile trailer units is provided wherein each unit includes self-contained, independent power systems (as set forth hereinabove and below) and each unit is constructed and configured with a reinforced frame and all-terrain mobility suspension and traction systems. Since tragic or catastrophic events and/or natural disasters often overwhelm local responder organizations and/or existing public services infrastructure, like fire and police services, a distributed network of mobile trailer units provides a scalable solution to the problem. Preferably, the mobile trailer units are designed, constructed and configured to be operable for supporting functions and services for response to a variety of situations, including but not limited to hazardous materials containment, clean-up and/or decontamination; medical services; communications and/or command center coordination; and combinations thereof. Preferably, in a distributed network, the vehicles are designed so that power supplies may be transmitted or transferred between vehicles so that if any unit has damaged or inoperable independent power, the network of vehicles can function to provide a temporary “grid” by sharing power generated from one unit to another through conduits operable to connect the units across a predetermined distance.

The network of trailer units, or “village” of trailers, are brought together and arranged and configured in the time of an emergency, pandemic, or other time of need, where each of the trailer units, have different roles in the network, community, or village (command center, communications, grocery, medical, sleeping, etc.) yet linked together create a common power grid that allows some trailers that are presently occupied (for example, a command or medical application) to utilize the independent power system of the trailers (like sleeping quarters) that are not occupied.

One embodiment of the present invention also provides a ruggedized mobile trailer including a superior insulated envelope construction for providing interior temperature management, including cooling capabilities even in extreme heat conditions. While prior art typically provides R-5 to R-11 insulation, this is insufficient for practical insulation and interior temperature management, especially cooling or heating in extreme conditions. Preferably, the present invention optionally includes a superior R-18 or greater insulated envelope construction wherein the entire trailer walls, roof, etc. are encapsulating the mobile unit with continuous insulation even throughout the corners of the unit, and including walls, ceilings, etc. Floors may also optionally be insulated.

Referring now to the drawings in general, the illustrations are for the purpose of describing a preferred embodiment of the invention and are not intended to limit the invention thereto.

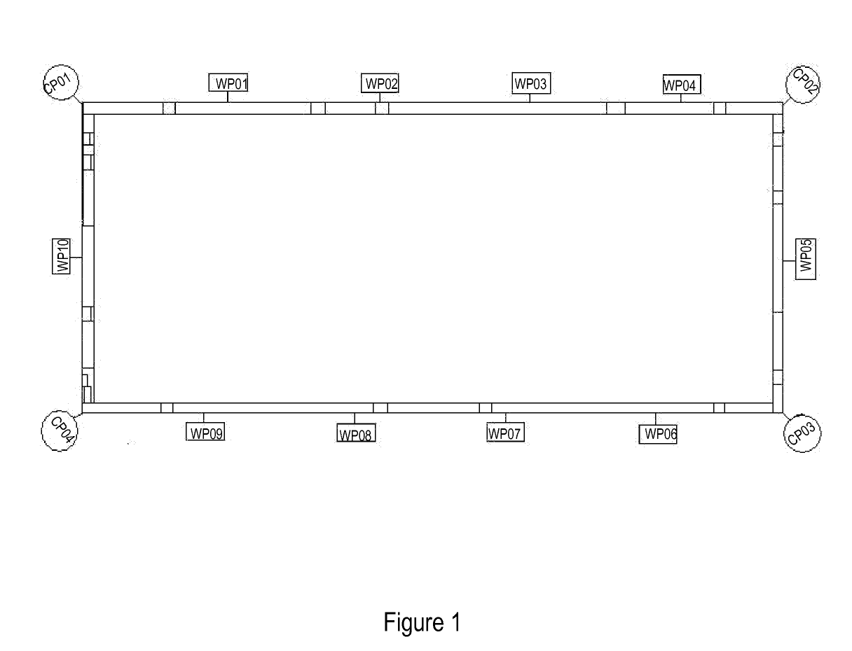

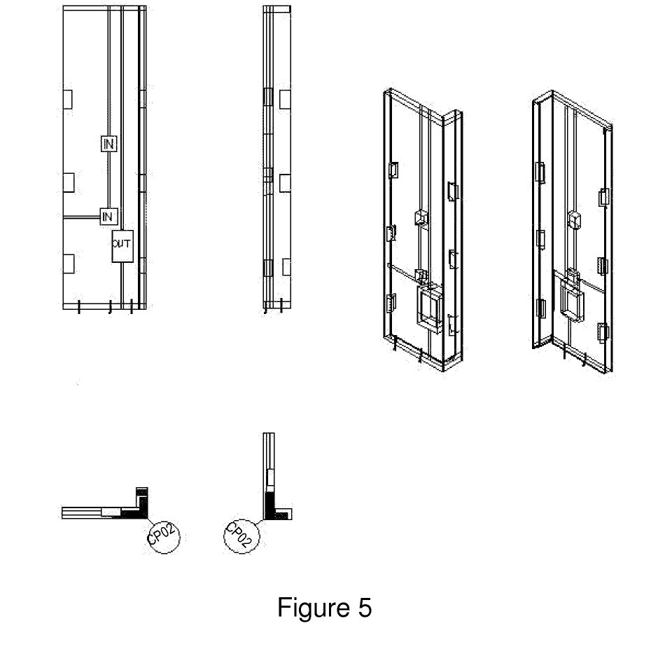

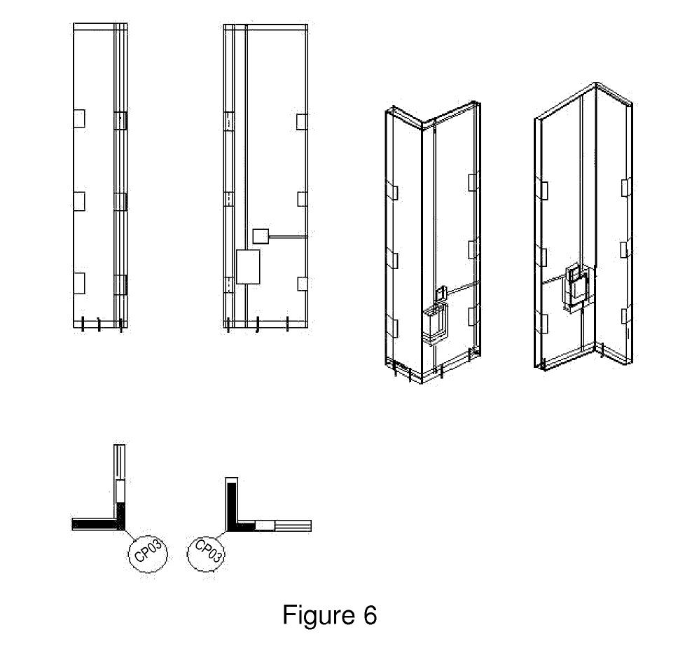

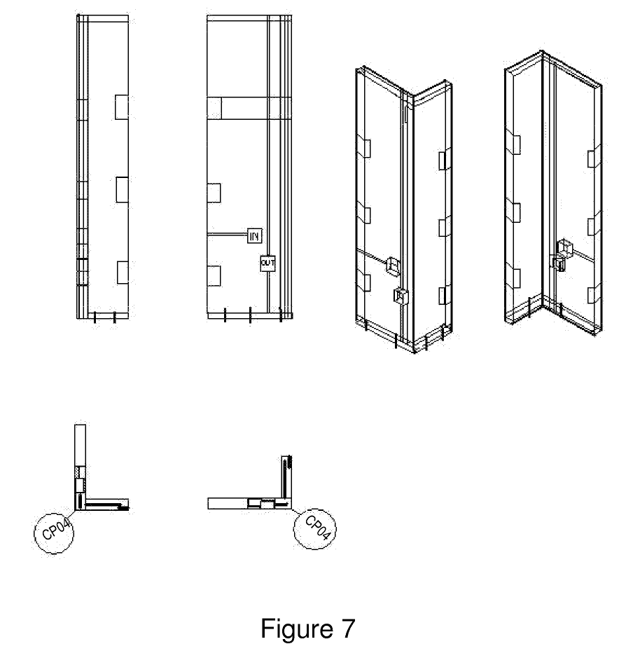

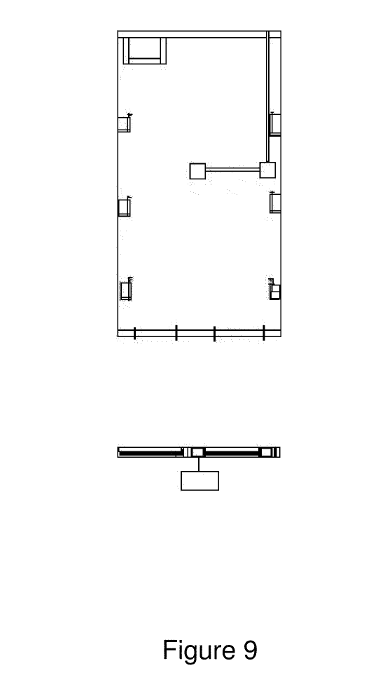

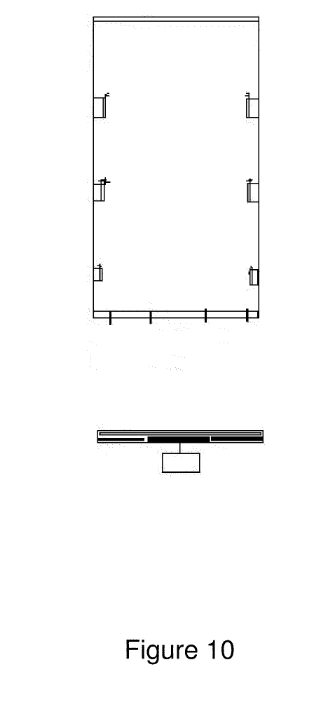

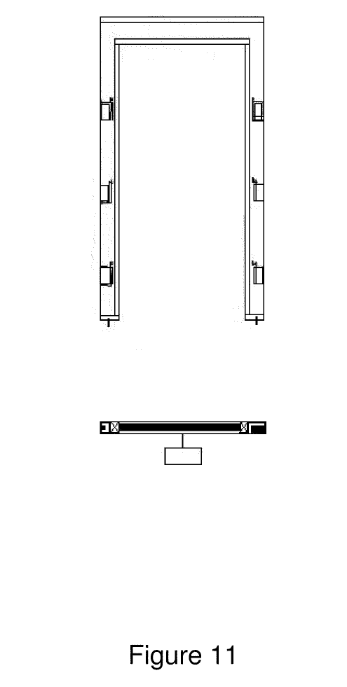

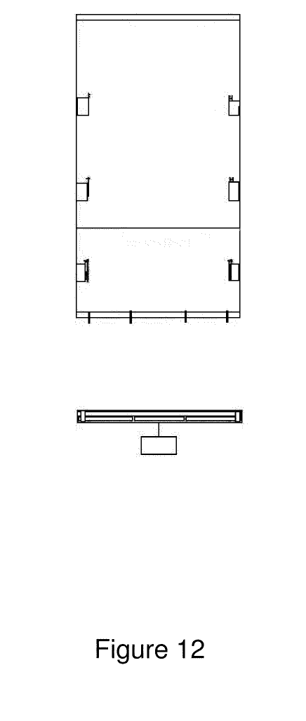

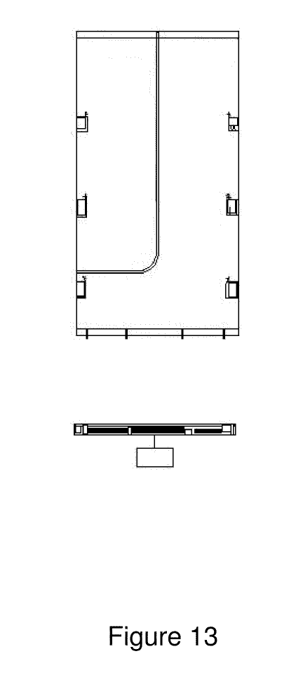

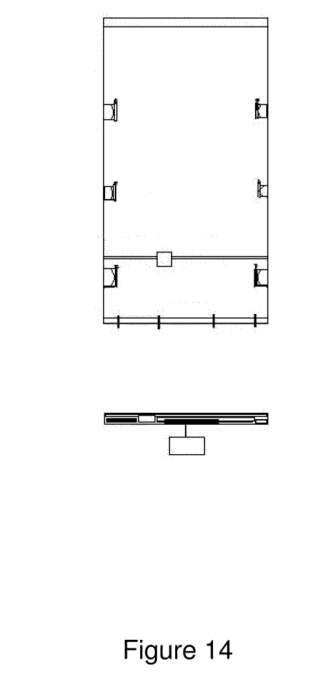

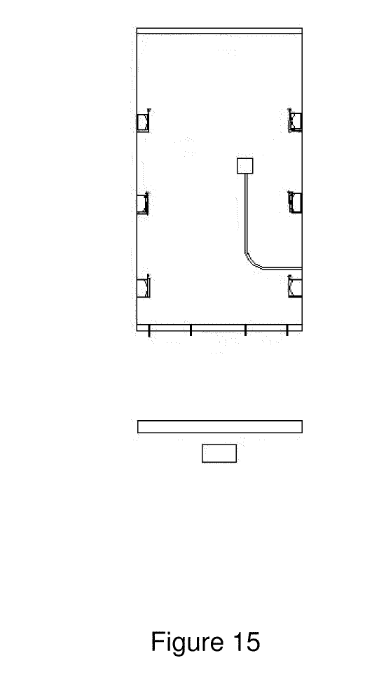

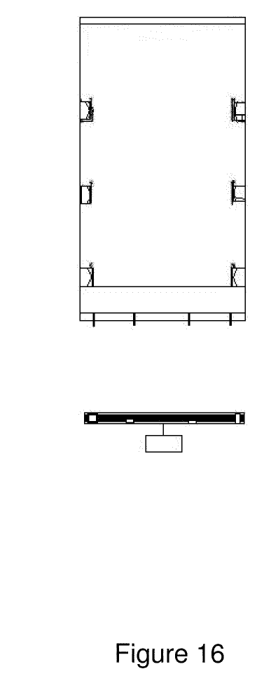

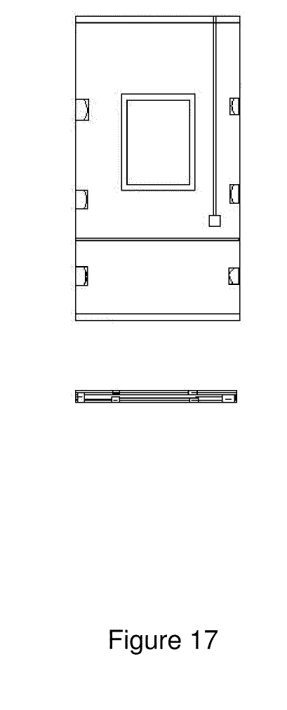

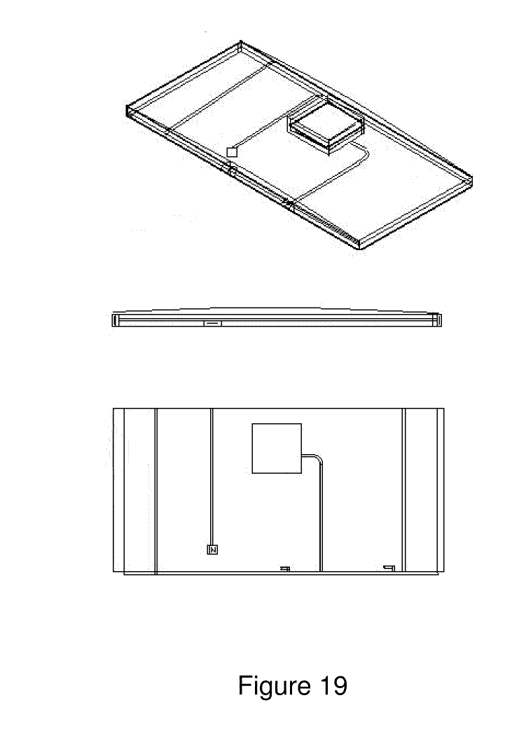

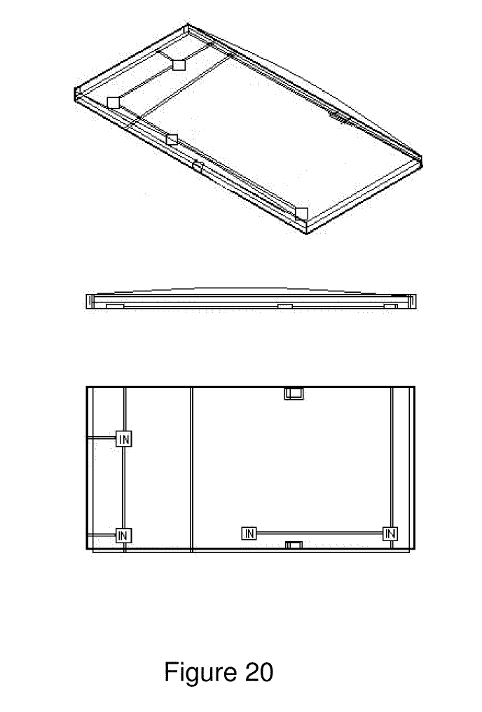

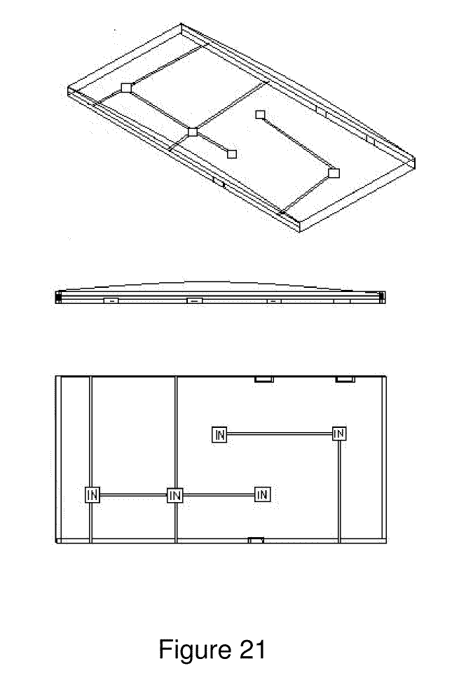

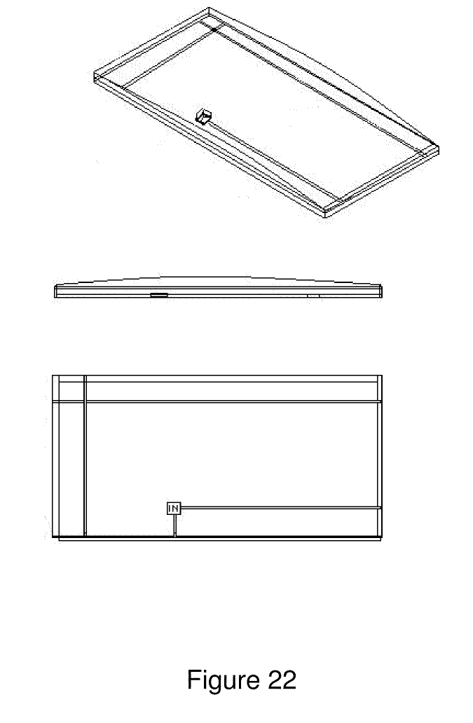

The FIGS. 1-22 provide various views of the mobile trailer and/or components of an embodiment of the present invention, showing “deck on frame” construction to provide ruggedized mobility including off-road conditions, and further provides various views of panel construction, electrical schematics, etc. for modular components of a trailer before assembly.

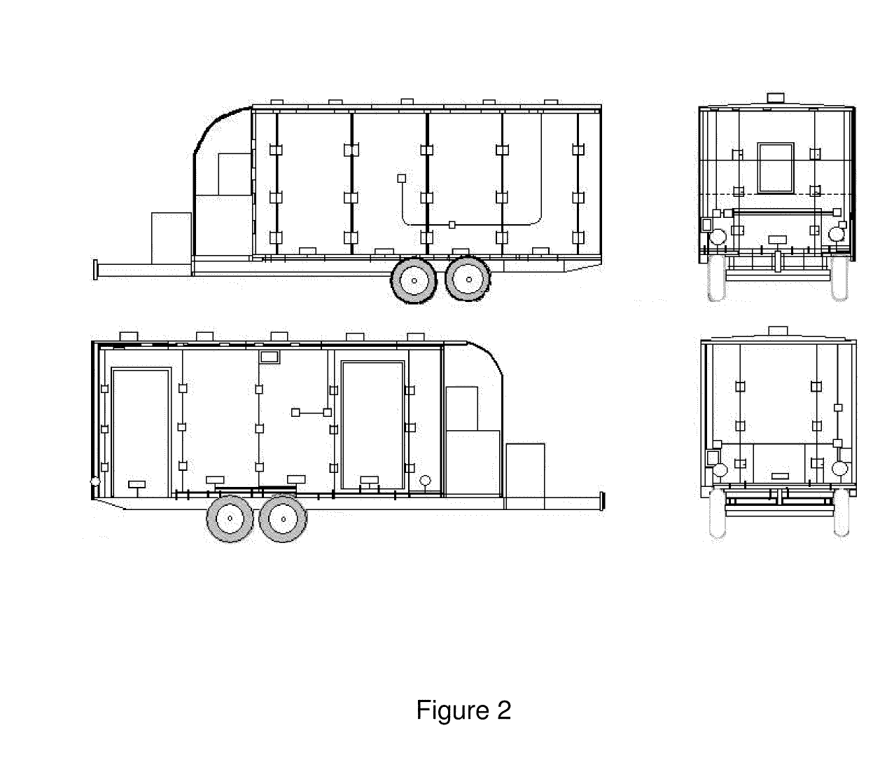

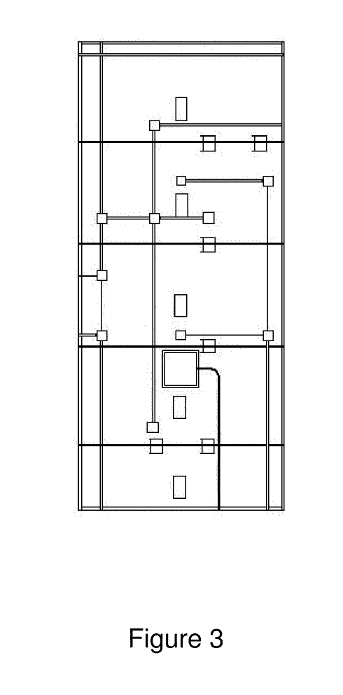

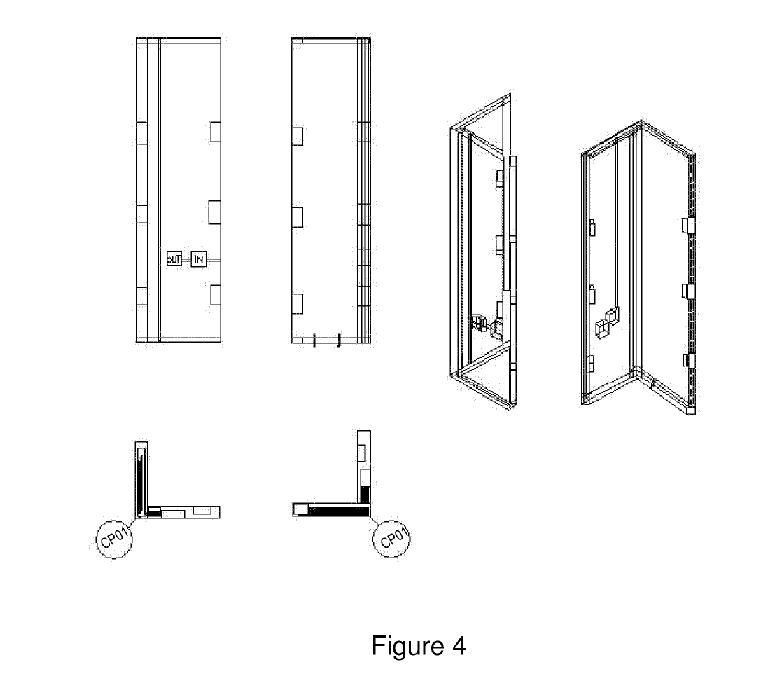

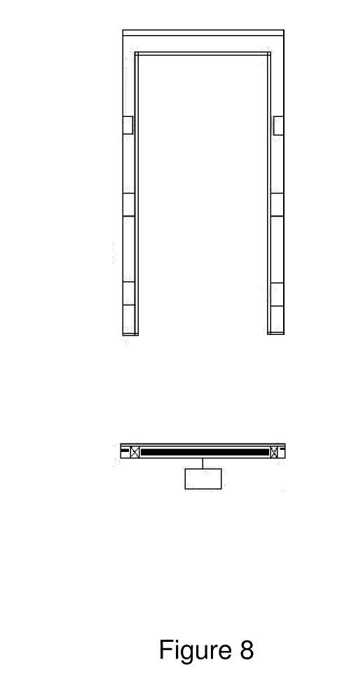

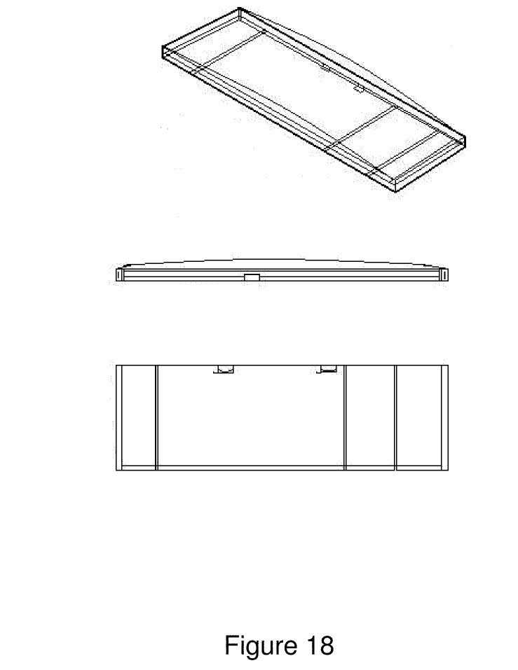

FIG. 1 illustrates a top view of a trailer unit according to the present invention; FIG. 2 illustrates a side view and end view of the trailer unit of FIG. 1; FIG. 3 illustrates an end view of the trailer of FIG. 1. FIGS. 4-7 illustrate multiple views of insulated structural panels or lining used with the present invention. FIGS. 8-17 illustrate a view of the top plate, bottom plate, and header used with the present invention. FIGS. 18-22 illustrate an exterior isometric view and other views of a section of the trailer unit according to the present invention. The insulative envelope provided by the present invention trailer unit is illustrated in the Figures and for maintaining climate control in extreme conditions, whether for cooling or for heating to maintain climate control within the trailer unit.

Certain modifications and improvements will occur to those skilled in the art upon a reading of the foregoing description. The above mentioned examples are provided to serve the purpose of clarifying the aspects of the invention and it will be apparent to one skilled in the art that they do not serve to limit the scope of the invention. While rapid- and first-response situations are more explicitly addressed, the present invention is applicable to domestic and international relief situations. Additionally, modular panel or lining for the siding construction provides for supplemental functionality, such as, by way of example and not limitation, including and/or integrating ballistic-resistant materials or composites with the siding, such as Dyneema. All modifications and improvements have been deleted herein for the sake of conciseness and readability but are properly within the scope of the present invention.

What is claimed is:

1. A mobile trailer unit comprising self-contained, independent power systems and each unit being constructed and configured with a reinforced frame and all-terrain mobility suspension and traction systems.

2. The trailer unit of claim 1, wherein the power systems are integrated with the unit.

3. The trailer unit of claim 1, wherein the power systems include solar power unit(s).

4. The trailer unit of claim 1, wherein the power systems include at least one generator unit.

5. The trailer unit of claim 1, wherein the power systems include wind power unit(s).

6. The trailer unit of claim 1, wherein the power systems include a battery-based power unit(s).

7. The trailer unit of claim 1, wherein the unit is constructed and configured with a reinforced frame or employs “deck on frame” trailer construction.

8. The trailer unit of claim 1, wherein the unit further includes all-terrain mobility suspension and traction systems.

9. A distributed network of mobile trailer units comprising at least two trailer units, wherein each unit includes self-contained, independent power systems.

10. The network of claim 9, wherein the power systems are integrated with the unit.

11. The network of claim 9, wherein the power systems are selected from solar power unit(s), generator unit(s), wind power unit(s), battery-based power unit(s), and combinations thereof.

12. The network of claim 9, wherein the unit is constructed and configured with a reinforced frame.

13. The network of claim 9, wherein the unit further includes all-terrain mobility suspension and traction systems.

14. The network of claim 9, wherein the insulation is R5 or greater.

15. A ruggedized mobile trailer comprising a trailer having an insulated envelope construction surrounding the internal cavity of the trailer for providing interior temperature management, including climate control capabilities for maintaining a predetermined internal temperature and humidity control within the trailer in normal and extreme temperature conditions.

16. The trailer of claim 15, wherein the power systems are integrated with the unit.

17. The trailer of claim 15, wherein the power systems are selected from solar power unit(s), generator unit(s), wind power unit(s), battery-based power unit(s), and combinations thereof.

18. The trailer of claim 15, wherein the unit is constructed and configured with a reinforced frame.

19. The trailer of claim 15, wherein the unit further includes all-terrain mobility suspension and traction systems.
